(19) United States
(12) Patent Application Publication
(10) Pub. No.: US 2012/0128844 A1
(43) Pub. Date: May 24, 2012

(54) Food Safe Vinyl Fondant Mat

(76) Inventor: Katherine Gentry, Goodlettsvile, TN (US)

(21) Appl. No.: 13/074,217

(22) Filed: Mar. 29, 2011

Related U.S. Application Data
(60) Provisional application No. 61/319,688, filed on Mar. 31, 2010.

(51) Int. Cl. A23P 1/08; C08K 5/1515; A21C 14/00

(52) U.S. Cl. 426/383; 428/220; 99/450.1; 524/114

(57) ABSTRACT

A Fondant Mat that provides for application without the use of confectioner's sugar or cornstarch while rolling out their fondant, which alters the recipe and dries out the fondant.

The present invention is a food safe, vinyl mat intended for the use of rolled fondant icing preparation (rolling flat with a rolling pin) and application of the icing to cakes. Additional applications may include the preparation (rolling flat with a rolling pin) and application of pie dough to pie pans and the preparation (rolling flat with a rolling pin) of cookie dough before cutting dough into shapes for baking.

### TITLE OF THE INVENTION

The present invention is titled “THE MAT”. Inventors include Kathy Gentry, Nashville, Tenn., USA, and John Gentry, Nashville, Tenn., USA.

### CROSS REFERENCE TO RELATED APPLICATIONS

Not applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not applicable

### BACKGROUND OF THE INVENTION

The present invention is in the field of cake decorating. More particularly, the present invention is primarily in the field of rolled fondant icing application, and may be used as well for pie or cookie dough preparation. Present applications consist of silicon based mats. These mats do not have the same working properties as the present invention, particularly when referring to the ease of preparation and applying the food product. Although patents may be in existence for these silicon based mats, they have not been identified through our research.

### SUMMARY OF THE INVENTION

The present invention is a Fondant Mat. The present invention is made of a food safe vinyl that allows the user to roll out fondant without sugars or starches and then apply the fondant to a cake with ease of release. While other inventions intended for similar use are made out of silicon, they do not provide the easy release of the present invention. While vinyl based material is readily available, the present invention offers a food safe alternative, avoiding the health hazards that scientists now claim other vinyl materials may present to humans.

### BRIEF DESCRIPTION OF THE DRAWINGS

FIG. 1 is a perspective view of the present invention.

FIG. 2 is a top view of the present invention.

FIG. 3 is perspective view of the present invention.

### DETAILED DESCRIPTION OF THE INVENTION

The advantages of the present invention include, without limitation, allowing the user to work with a tool that does not require the use of powders such as confectioner's sugar or cornstarch while rolling out their fondant, which alters the recipe and dries out the fondant. The invention also allows for a covering of the fondant so that the air itself does not dry out the fondant while rolling it out. The invention also provides a special polish, so that, when a user pulls taught and creates surface tension, it releases the fondant on to the cake with great ease. Additionally, cake decorators can be assured that because this is a food safe alternative tool, no Phthalates or heavy metals are present which are found in other materials, and which scientists currently claim may cause various health problems from allergy sensitivity to infertility to cancer. In broad embodiment, the present invention is a food safe vinyl based mat consisting essentially of calendered PVC, with DOTP plasiticizer, epoxy soybean oil and other CFR listed raw materials, intended for rolling out and applying fondant. Fondant mats exist that are made of food grade silicon. These mats claim to have non stick properties, but in fact the silicon itself has a sticky property to it that does not allow the fondant to release from the mat as easily as it does with the vinyl component in the present invention.

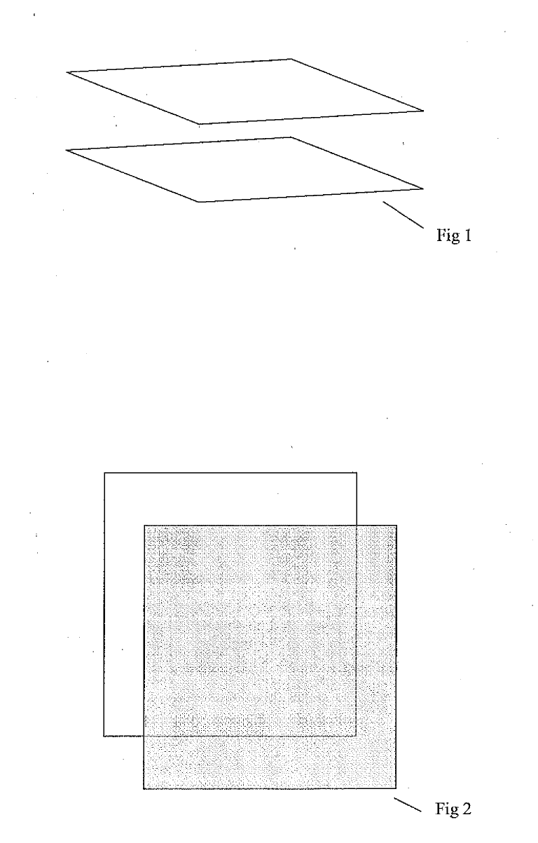

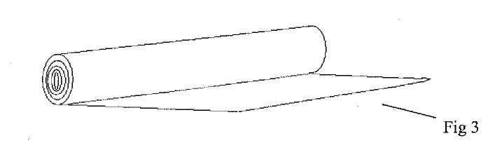

FIG. 1 shows a perspective view of two identical but separate vinyl based sheets, comprised of food safe ingredients, of a 12 gauge measurement. FIG. 2 shows a top view of same identical but separate vinyl based sheets. FIG. 3 shows a perspective view of the sheets, rolled up together to exhibit their flexibility.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention as claimed, including, but not limited to, size, rigidity, gauge, or durability.

What is claimed is:

1. A Fondant Mat, consisting essentially of:
calendered PVC, with DOTP plasiticizer, epoxy soybean oil and other CFR listed raw materials.

2. The Fondant Mat of claim 1, further consisting essentially of a thickness of approximately 12 gauge.

3. The Fondant Mat of claim 1, further consisting essentially of a duplicate mat that may or may not accompany the primary mat for ideal fondant preparation and application.

4. A method of decorating a food item comprising:
(a) providing the food item;
(b) providing two sanitary, highly buffed mats between which to prepare the rolled fondant icing;
(c) rolling out the fondant icing on the mat to then apply fondant icing to the food item;
(d) removing top mat and setting aside during application process:
(e) applying the rolled fondant icing to the food item by laying over the food item while still slightly adhered to the mat;
(f) beginning to remove fondant mat from rolled fondant icing by pulling the fondant icing away from the mat a few inches, allowing gravity to begin pulling fondant away from the mat further;
(g) finish removing fondant from fondant mat by creating a surface tension by pulling taught from each side, which complements the highly buffed surface of the fondant mat, allowing the fondant to easily roll off into the proper place on the food item.

5. A method of decorating a food item of claim 4, further comprising:
providing fondant mat with highly buffed surface with composition of claim 1, that when combined with this method, offers a result that allows the fondant to stick long enough to allow the user to transfer the fondant icing onto the food item easily, no matter the size or weight of the fondant icing, and then easily and quickly remove the fondant icing from the fondant mat.

6. &Fondant Mat, comprising:
(a) providing a food safe vinyl based mat, without the use of BPA, Phthlates, and heavy metals in other vinyl mats, which have been indicated to show a variety of health problems in humans;
(b) providing a surface that allows the user to prepare fondant icing without using cornstarch or powdered sugar, which dries out the fondant and can cause fermentation, as well as changing the taste and texture of the icing;
(c) providing a second, duplicate fondant mat that, when covering the top surface of the fondant icing, prevents further drying of the fondant icing from airflow;
(d) providing a fondant mat that allows users to transfer fondant icing to a food item without previous difficulty.

7. A Fondant Mat, comprising:
(a) a food safe mat that may or may not have markings, print, or indications in increments to guide the user to the size to which the food needs to be stretched for application;
(b) a food safe mat that may or may not contain a printed chart indicating the manufacturer's recommendations for the amount of food product needed in order to cover specific sizes of cake, cookie, pan, or any other intended food or non food item intended to be covered with another food item prepared on the mat.

8. A Food Preparation Mat, comprising:
a food safe work mat that may be used for preparing icings, cookie dough, pie dough, pizza dough, and other foods

9. A method of decorating a food item comprising:
(a) providing the food item;
(b) providing two sanitary, highly buffed mats between which to prepare the rolled fondant icing;
(c) rolling out the fondant icing on the mat to then apply fondant icing to the food item;
(d) removing top mat by pulling back away from fondant icing;
(e)layering cut outs of other colors, sizes, shapes of fondant icing onto the first layer of rolled fondant to create a decorative pattern;
(f) replacing top mat to the top of the fondant icing, covering both the fondant and the inlaid patterns;
(g) Rolling patterns into the fondant with a rolling pin;
(h) flipping both mats over onto the work surface, leaving the top mat on the bottom and the bottom mat on the top in order to expose the pattern side down;
(i) removing what is now the top mat and setting aside during application process;
(j) applying the rolled fondant icing to the food item by laying over the food item while still slightly adhered to the mat;
(k) beginning to remove fondant mat from rolled fondant icing by pulling the fondant icing away from the mat a few inches, allowing gravity to begin pulling fondant away from the mat further;
(l) finish removing fondant from fondant mat by creating a surface tension by pulling taught from each side, which complements the highly buffed surface of the fondant mat, allowing the fondant to easily roll off into the proper place on the food item.
